(19) United States
(12) Patent Application Publication
(10) Pub. No.: US 2023/0244860 A1
(43) Pub. Date: Aug. 3, 2023

(54) INFORMATION PROCESSING APPARATUS, INFORMATION PROCESSING METHOD, AND INFORMATION PROCESSING SYSTEM

(71) Applicant: Ryo Iwasaki, Tokyo (JP)

(72) Inventor: Ryo Iwasaki, Tokyo (JP)

(73) Assignee: Ricoh Company, Ltd., Tokyo (JP)

(21) Appl. No.: 18/053,502

(22) Filed: Nov. 8, 2022

(30) Foreign Application Priority Data
Jan. 31, 2022 (JP) 2022-013474

(51) Int. Cl. G06F 40/174

(52) U.S. Cl. CPC G06F 40/174

(57) ABSTRACT

An information processing apparatus includes circuitry to display, on a display of a terminal device, an input screen, in a case that predetermined information included in form information is edited and edited predetermined information is obtained. The input screen is for inputting information related to the edited predetermined information. The form information is information representing a content of a form The circuitry stores, in a memory, management information in which the information input via the input screen and the edited predetermined information are associated with each other.

### CROSS-REFERENCE TO RELATED APPLICATIONS

This patent application is based on and claims priority pursuant to 35 U.S.C. § 119(a) to Japanese Patent Application No. 2022-013474, filed on Jan. 31, 2022, in the Japan Patent Office, the entire disclosure of which is hereby incorporated by reference herein.

### BACKGROUND

### Technical Field

The present disclosure relates to an information processing apparatus, an information processing method, and an information processing system.

### Related Art

Systems for extracting items and values of the items included in a form image and managing form information in which the items and the values of the items are associated with each other have been known.

Predetermined information included in the form information managed by such a system may be edited. Editing of the predetermined information can be performed according to convenience of a user.

### SUMMARY

An embodiment of the present disclosure includes an information processing apparatus including circuitry to display, on a display of a terminal device, an input screen, in a case that predetermined information included in form information is edited and edited predetermined information is obtained. The input screen is for inputting information related to the edited predetermined information. The form information is information representing a content of a form. The circuitry stores, in a memory, management information in which the information input via the input screen and the edited predetermined information are associated with each other.

An embodiment of the present disclosure includes an information processing method including displaying, on a display of a terminal device, an input screen, in a case that predetermined information included in form information is edited and edited predetermined information is obtained. The input screen is for inputting information related to the edited predetermined information. The form information is information representing a content of a form. The method includes storing, in a memory, management information in which the information input via the input screen and the edited predetermined information are associated with each other.

An embodiment of the present disclosure includes an information processing system including an information processing apparatus and a terminal device. The information processing apparatus includes information processing circuitry, and the terminal device includes terminal device circuitry. The information processing apparatus and the terminal device are connected to each other via a network. The information processing apparatus circuitry receives a display request transmitted from the terminal device in a case that predetermined information included in form information is edited, and edited predetermined is obtained on the terminal device. The form information is information representing a content of a form The information processing apparatus circuitry displays, in response to the display request, on a display of the terminal device, an input screen for inputting information related to the edited predetermined information. The information processing apparatus circuitry stores, in a memory, management information in which the information input via the input screen and the edited predetermined information are associated with each other. The terminal device circuitry receives an operation of editing the form information and controls the display to display the input screen.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a form recognition system according to an exemplary embodiment of the disclosure;

FIG. 2 is a block diagram illustrating an example of a hardware configuration of a server apparatus according to the exemplary embodiment of the disclosure;

FIG. 3 is a block diagram illustrating a hardware configuration of a terminal device according to the exemplary embodiment of the disclosure;

FIG. 4 is a diagram illustrating an example of type-determination database according to the exemplary embodiment of the disclosure;

FIG. 5 is a diagram illustrating types of form definition information stored in a form definition database according to the exemplary embodiment of the disclosure;

FIG. 6 is a diagram illustrating an example of general purpose definition information according to the exemplary embodiment of the disclosure;

FIG. 7 is a diagram illustrating an example of individual company definition information according to the exemplary embodiment of the disclosure;

FIG. 8 is a diagram illustrating an example of specific definition information according to the exemplary embodiment of the disclosure;

FIG. 9 is a diagram illustrating an example of a management information database according to the exemplary embodiment of the disclosure;

FIG. 10 is a block diagram illustrating a functional configuration of the server apparatus according to the exemplary embodiment of the disclosure;

FIG. 11 is a block diagram illustrating an example of a functional configuration of the terminal device according to the exemplary embodiment of the disclosure;

FIG. 12 is a sequence diagram illustrating an operation of the form recognition system according to the exemplary embodiment of the disclosure;

FIG. 13 is a diagram illustrating an example of a job list according to the exemplary embodiment of the disclosure;

FIG. 14 is a flowchart illustrating a process performed by a form recognition unit according to the exemplary embodiment of the disclosure;

FIG. 15 is a flowchart illustrating another process performed by the form recognition unit according to the exemplary embodiment of the disclosure;

FIG. 16 is a flowchart illustrating still another process performed by the form recognition unit according to the exemplary embodiment of the disclosure;

FIG. 17 is a flowchart illustrating a process performed by a form management unit according to the exemplary embodiment of the disclosure;

FIG. 18 is a diagram illustrating a display example of the terminal device according to the exemplary embodiment of the disclosure;

FIG. 19 is a diagram illustrating another display example of the terminal device according to the exemplary embodiment of the disclosure; and

FIG. 20 is a diagram illustrating still another display example of the terminal device according to the exemplary embodiment of the disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

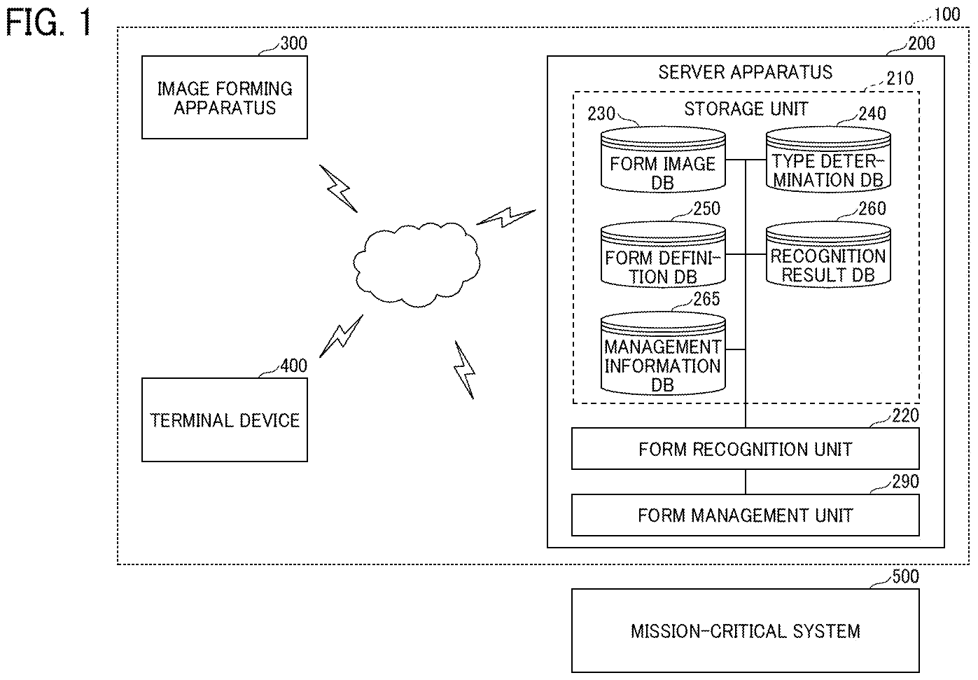

Embodiments of the present disclosure are described below with reference to the drawings. FIG. 1 is a diagram illustrating an example of a system configuration of a form recognition system according to an embodiment.

The form recognition system 100 according to the present embodiment includes a server apparatus 200, an image forming apparatus 300, and a terminal device 400. In the form recognition system 100 according to the present embodiment, the server apparatus 200, the image forming apparatus 300, and the terminal device 400 are connected via a network.

The form recognition system 100 according to the present embodiment is an example of an information processing system.

The terminal device 400 according to the present embodiment is connected to a mission-critical system 500 via a network, for example. The mission-critical system 500 is, for example, a system that performs specific processing using a result of recognizing a form with the form recognition system 100 according to the present embodiment. Specifically, for example, the mission-critical system 500 may be an accounting system or an estimate creation system.

In the form recognition system 100 according to the present embodiment, the server apparatus 200 extracts an item and a value of the item included in a form from image data representing an image of the form read by a scanner function of the image forming apparatus 300, and generates text data in which the item and the value of the item are associated with each other.

In the following description, an image of a form, or a form image, read by the scanner function of the image forming apparatus 300 is referred to as a form image, and image data representing the form image is referred to as form image data. The image forming apparatus 300 may not be included in the form recognition system 100.

In addition, in the following description, extracting an item included in a form image and an item value, which is a value of the item, and associating the item with the item value is referred to as form recognition.

The server apparatus 200 according to the present embodiment includes a storage unit 210, a form recognition unit 220, and a form management unit 290. The storage unit 210 includes a form image database (DB) 230, a type-determination database 240, a form definition database 250, a recognition result database 260, and a management information database 265.

The form image database 230 stores the form image data. The type-determination database 240 stores information to be referred to in determining a type of the form. The form definition database 250 stores description definition information that is referred to when the form recognition unit 220 performs form recognition. The recognition result database 260 stores form information (recognition result data) that is information indicating a result of form recognition performed by the form recognition unit 220. The management information database 265 stores management information for managing the form information.

The form recognition unit 220 according to the present embodiment acquires the form image data, which is stored in the form image database 230, determines a type of the form with reference to the type-determination database 240, and specifies description definition information to be referred to. Then, the form recognition unit 220 performs form recognition using the identified description definition information in the form definition database 250, and stores form information acquired as a result of the form recognition in the recognition result database 260. The description definition information includes an item name of a description item (description item name) included in the form and information indicating a described position of the item name.

When performing form recognition, the form recognition unit 220 according to the present embodiment refers to general purpose definition information, individual company definition information, and specific definition information stored in the form definition database 250.

The general purpose definition information according to the present embodiment is information that defines a word corresponding to a description item name in a general form.

The individual company definition information is information defining a word corresponding to a description item name in a form unique to a user using the form recognition system 100 and information extracted from a form image. The specific definition information is form definition information that defines a specific form issued by, for example, a specific business operator, or a specific company. Specifically, the specific form is, for example, a slip that is generally used by couriers. Details of the type-determination database 240 and the form definition database 250 are described later.

In the present embodiment, as described above, by using three types of description definition information at the time of performing form recognition, in addition to a general purpose form, a description part of the form is recognizable, resulting in improving the accuracy of form recognition.

When predetermined information included in the form information corresponding to a result recognized by the form recognition unit 220 is edited, the form management unit 290 according to the present embodiment displays an input screen for inputting information related to the predetermined information.

Then, the form management unit 290 stores management information in which the information related to the predetermined information is associated with the edited predetermined information in the management information database 265.

The predetermined information in the present embodiment is information that is to be a main key used for managing the form information stored in the recognition result database 260. Specifically, the predetermined information includes information indicating an issuer of the form, or a form issuer.

The issuer of a form, or the form issuer, in the present embodiment indicates a name of a corporation or an individual who issued the form, and does not include a name of a branch office or a department.

The information related to the predetermined information includes the predetermined information and information (identification information) for identifying the edited predetermined information. In other words, the information related to the predetermined information is information on an issuer of a form (form issuer), and includes information indicating the issuer of the form and information identifying an issuer after editing.

Accordingly, the management information according to the present embodiment includes the predetermined information, information identifying the edited predetermined information, and the edited predetermined information. In other words, the management information includes the issuer of the form, information for identifying the issuer after editing, and the issuer after editing.

As described above, in the present embodiment, the predetermined information and the edited predetermined information are stored as separate items in association with each other in the management information database 265.

Accordingly, in the present embodiment, even when the predetermined information included in the form information is edited, the form information can be managed in the same manner as in a status where the predetermined information is not edited, and the form information can be efficiently managed, by referring to the management information.

In the form recognition system 100 according to the present embodiment, the image forming apparatus 300 is a multifunction peripheral having a scanner function. On the image forming apparatus 300, applications for implementing, for example, a copy function, a facsimile function, and a scanner function are installed, and each of the functions is implemented by selecting corresponding one of the applications.

The terminal device 400 according to the present embodiment is used by a user who uses the form recognition system 100. In addition, for example, a screen for confirming a result of form recognition performed by the server apparatus 200 may be displayed on the terminal device 400.

The user in the present embodiment includes a business place, a company, and an organization that concludes a contract for using a service provided by the form recognition system 100.

In the example of FIG. 1, the server apparatus 200 includes five databases in the storage unit 210, but the present disclosure is not limited to this. A part of the databases may be provided in an external device of the server apparatus 200, or all of the databases may be provided in an external device.

In the example illustrated in FIG. 1, the server apparatus 200 implements the form recognition unit 220 and the form management unit 290, but the present disclosure is not limited to this. The form recognition unit 220 and the form management unit 290 may be implemented by a plurality of information processing apparatuses.

In the form recognition system 100 in the example of FIG. 1, each of the number of image forming apparatuses 300 and the number of terminal devices 400 is one, however, each of the number of image forming apparatuses 300 and the number of terminal devices 400 included in the form recognition system 100 may be any number.

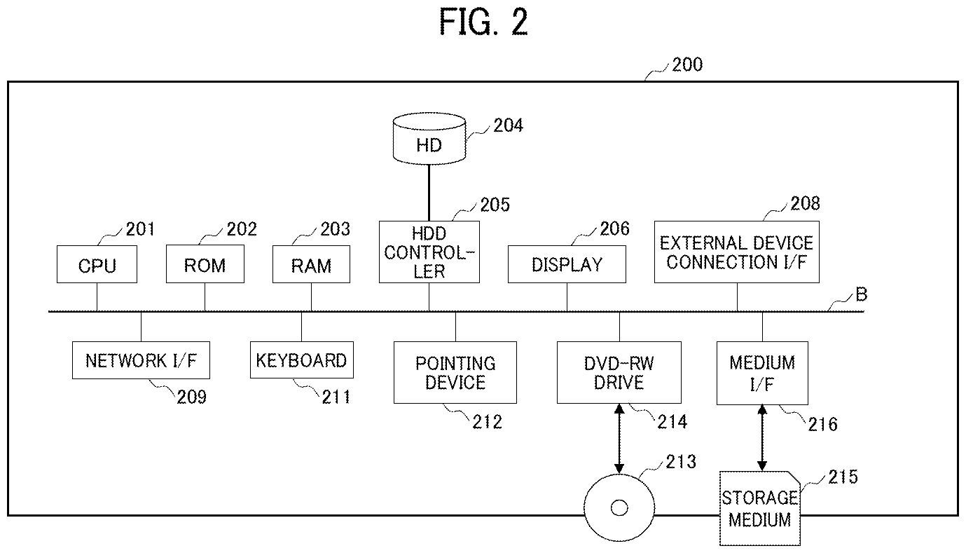

Next, a hardware configuration of the server apparatus 200 according to the present embodiment is described with reference to FIG. 2. FIG. 2 is a block diagram illustrating an example of a hardware configuration of the server apparatus 200 according to the present embodiment.

As illustrated in FIG. 2, the server apparatus 200 includes a central processing unit (CPU) 201, a read only memory (ROM) 202, a random access memory (RAM) 203, a hard disk (HD) 204, a hard disk drive (HDD) controller 205, a display 206, an external device connection interface (I/F) 208, a network I/F 209, a data bus B, a keyboard 211, a pointing device 212, a digital versatile disc rewritable (DVD-RW) drive 214, and a medium I/F 216.

The CPU 201 controls the entire operation of the server apparatus 200. The ROM 202 stores a program such as an initial program loader (IPL) used for driving the CPU 201. The RAM 203 is used as a work area for the CPU 201. The HD 204 stores various data such as a control program. The HDD controller 205 controls reading and writing of various data from and to the HD 204 under control of the CPU 201. The display 206 is a display device that displays various types of information such as a cursor, a menu, a window, characters, or an image.

The external device connection I/F 208 is an interface for connecting various external devices. Examples of the external devices include, but are not limited to, a universal serial bus (USB) memory and a printer. The network I/F 209 is an interface that controls communication of data through a communication network. The data bus B is an address bus, a data bus, or the like that electrically connects components, such as the CPU 201, illustrated in FIG. 2.

The keyboard 211 is an example of an input device provided with a plurality of keys for allowing a user to input characters, numerals, or various instructions. The pointing device 212 is an example of an input device that allows a user to select or execute a specific instruction, select a target for processing, or move a cursor being displayed. The DVD-RW drive 214 reads or writes various data from or to a DVD-RW 213, which is an example of a removable storage medium. The removable storage medium is not limited to the DVD-RW and may be a Digital Versatile Disc-Recordable (DVD-R) or the like. The medium I/F 216 controls reading or writing (storage) with respect to a recording medium 215 such as a flash memory.

The server apparatus 200 according to the present embodiment may be, for example, a smartphone, a tablet terminal, a personal digital assistant (PDA), or a wearable PC.

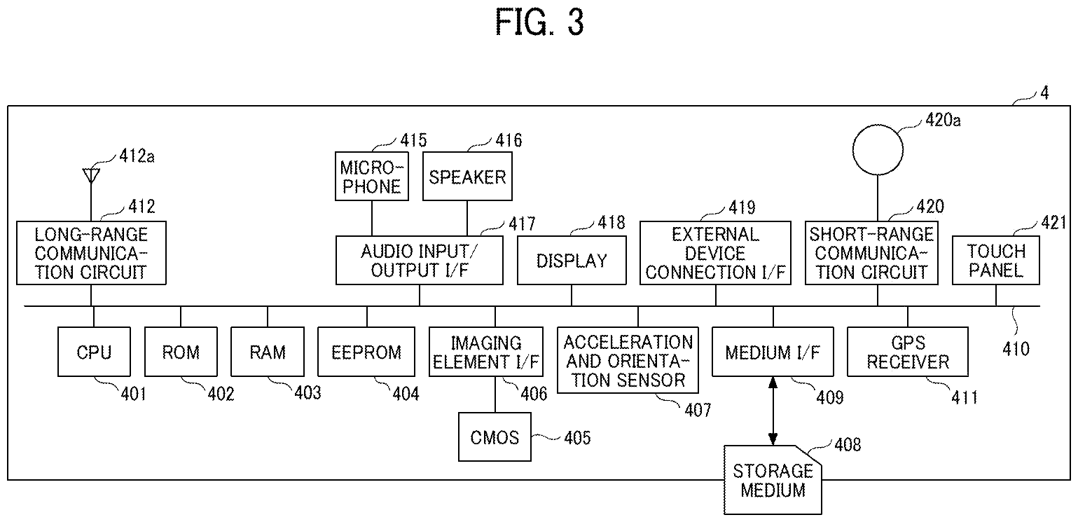

The terminal device 400 according to the present embodiment is a computer including an arithmetic processing device and a storage device, and may be, for example, a tablet terminal device or a smartphone. FIG. 3 is a block diagram illustrating a hardware configuration of the terminal device 400 according to the present embodiment.

The terminal device 400 according to the present embodiment includes a CPU 401, a ROM 402, a RAM 403, an electrically erasable and programmable ROM (EEPROM) 404, a complementary metal oxide semiconductor (CMOS) sensor 405, an imaging element I/F 406, an acceleration and orientation sensor 407, a medium I/F 409, a data bus 410, and a global positioning system (GPS) receiver 411.

The CPU 401 is a processor that controls entire operation of the terminal device 400. The ROM 402 stores a program for executing the CPU 401 such as an Initial Program Loader (IPL). The RAM 303 is used as a work area for the CPU 301. The EEPROM 404 reads or writes various data such as a control program for smartphones (terminal devices) under control of the CPU 401. The ROM 402, the RAM 403, and the EEPROM 404 are examples of storage devices of the terminal device 400.

The CMOS sensor 405 is an example of a built-in imaging device configured to capture an object (mainly, a self-image of a user) under control of the CPU 401 to obtain image data. In alternative to the CMOS sensor 405, an imaging element such as a charge-coupled device (CCD) sensor may be used.

The imaging element I/F 406 is a circuit that controls driving of the CMOS sensor 405. The acceleration and orientation sensor 407 includes various sensors such as an electromagnetic compass for detecting geomagnetism, a gyrocompass, and an acceleration sensor. The medium I/F 409 controls reading or writing (storage) of data to a storage medium 408 such as a flash memory. The data bus 410 is an address bus, a data bus, or the like that electrically connects components, such as the CPU 401, illustrated in FIG. 3. The GPS receiver 411 receives a GPS signal from a GPS satellite.

The terminal device 400 includes a long-range communication circuit 412, an antenna 412a of the long-range communication circuit 412, a microphone 415, a speaker 416, an audio input/output I/F 417, a display (display device) 418, an external device connection I/F 419, a short-range communication circuit 420, an antenna 420a of the short-range communication circuit 420, and a touch panel 421.

The long-range communication circuit 412 is a circuit that allows communication with other devices through a communication network. The microphone 415 is a built-in circuit that converts sound into an electric signal. The speaker 416 is a built-in circuit that generates sound such as music or voice by converting an electric signal into physical vibration. The audio input/output I/F 417 is a circuit for inputting and outputting an audio signal between the microphone 415 and the speaker 416 under the control of the CPU 401.

The display 418 is an example of a display device that displays an image of an object, various icons, etc. Examples of the display 418 include, but are not limited to, a liquid crystal display (LCD) and an organic electroluminescence (EL) display. The external device connection I/F 419 is an interface for connecting various external devices. The short-range communication circuit 420 is a communication circuit that communicates in compliance with the near field communication (NFC) or BLUETOOTH, for example. The touch panel 421 is an example of an input device that allows a user to input a user instruction to the terminal device 400 through touching a screen of the display 418. The display 418 is an example of a display (display device) included in the terminal device 400.

Next, the type-determination database 240 and the form definition database 250 included in the server apparatus 200 according to the present embodiment are described.

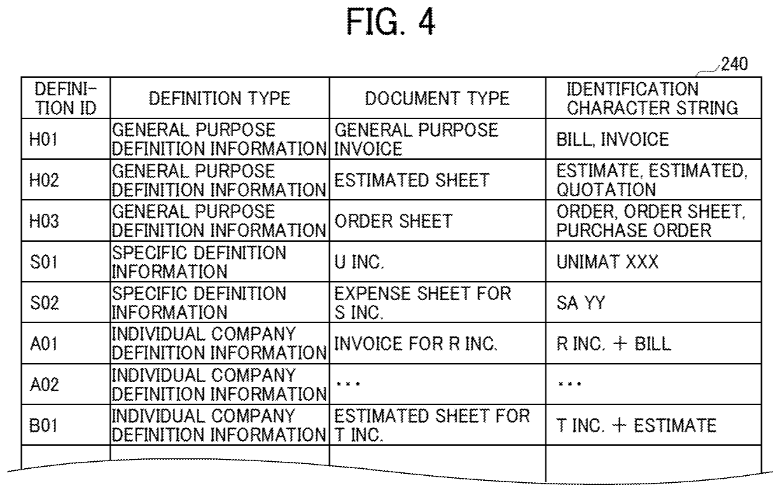

FIG. 4 is a diagram illustrating an example of type-determination database according to the present embodiment. The type-determination database 240 according to the present embodiment includes a definition ID, a definition type, a document type, and an identification character string, as information items. In the type-determination database 240, the item of “DEFINITION ID” is associated with the other items, and information including a value of the item of “DEFINITION ID” and values of the other items is referred to as type-determination information.

The value of the item of “DEFINITION ID” indicates identification information for identifying form definition information (corresponding to a record).

The value of the item of “DEFINITION TYPE” indicates a type of the form definition information. In the present embodiment, the types of form definition information include the specific definition information in addition to the general purpose definition information and the individual company definition information. The specific definition information is form definition information that defines a specific form issued by a specific business operator, or a specific company, for example. Specifically, the specific form is, for example, a slip that is generally used by couriers.

The value of the item of “DOCUMENT TYPE” indicates a type of form. Specifically, the type of form includes, for example, an invoice (bill), an estimate sheet, and an order sheet.

The value of the item “IDENTIFICATION CHARACTER STRING” indicates character strings for identifying the type of the form. Specifically, for example, in a form image including a character string “INVOICE” or “BILL,” the type of form indicated by the item of “DOCUMENT TYPE” is “INVOICE.”

In the example of FIG. 4, for example, the type of the form definition information of the definition ID of “H01” is general purpose definition information, and the general purpose definition information of the definition ID “H01” is information defining a layout of the “INVOICE,” and is referred to when the character string of “INVOICE” or “BILL” is extracted from the form image.

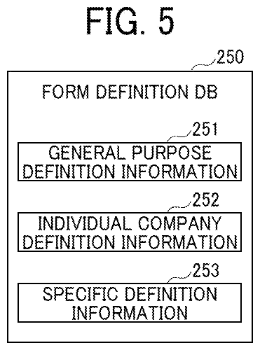

Next, the form definition database 250 according to the present embodiment is described with reference to FIGS. 5 to 8. FIG. 5 is a diagram illustrating types of form definition information stored in the form definition database according to the present embodiment.

In the form definition database 250 according to the present embodiment, general purpose definition information 251, individual company definition information 252, and specific definition information 253 are stored.

The general purpose definition information 251 according to the present embodiment is form definition information of a form with a layout having relatively high general purpose versatility among the forms so that a plurality of users uses. The general purpose definition information 251 is form definition information that has the lowest priority among the three pieces of form definition information.

The individual company definition information 252 according to the present embodiment is form definition information of a form with a layout that is uniquely designed by a user among the forms, and is form definition information dedicated to a specific user. The individual company definition information 252 is a definition to be most respected among the three pieces of form definition information, and is form definition information that has the highest priority.

The specific definition information 253 according to the present embodiment is form definition information indicating a layout of a generally used form among the forms. The priority of the specific definition information 253 is intermediate among the three pieces of form definition information.

The form recognition unit 220 according to the present embodiment performs recognition on the form image data by referring to the three pieces of form definition information. Accordingly, in the present embodiment, for example, even when the form image data is of a form whose layout is not defined in the general purpose definition information 251, the form image data can be recognized as long as the form image data is defined in the individual company definition information 252 or the specific definition information 253.

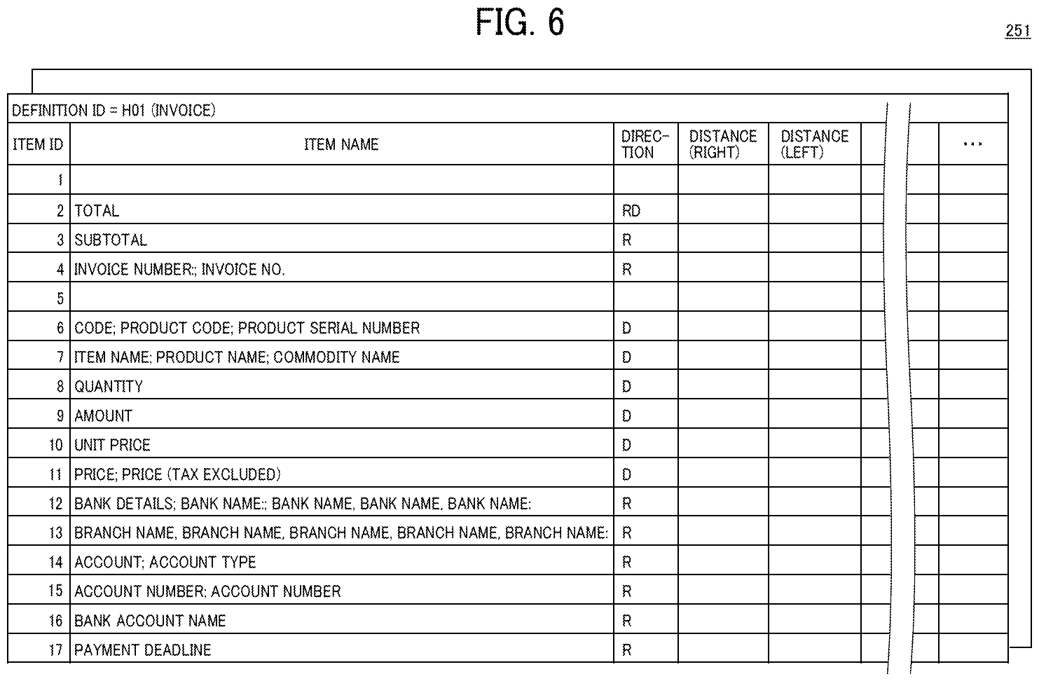

FIG. 6 is a diagram illustrating an example of general purpose definition information. The general purpose definition information 251 is generated for each definition ID and includes, as information items, an item ID, an item name, a direction, and a distance, for example. In other words, in the general purpose definition information 251 according to the present embodiment, the item of “DEFINITION ID” and the other items are associated with each other, and a value of the item of “DEFINITION ID” and the values of the other items are included.

The value of the item “ITEM ID” is identification information for identifying an item included in the form. The value of the item of “ITEM NAME” indicates a name of the item.

The items of, for example, “DIRECTION” and “DISTANCE” indicate a range from which a character string is extracted. For example, when a value of the item of “DIRECTION” is “RD” and a value of the item of “DISTANCE” is “20 mm,” a character string is to be extracted from a range within 20 mm downward from coordinates of a lower right corner of a rectangle circumscribing the character string that is the item name.

In other words, the items of “DIRECTION” and “DISTANCE” in the present embodiment are conditions indicating a range from which a character string is extracted, and the conditions are associated with each of the item names. In the example of FIG. 5, the items of “DIRECTION” and “DISTANCE” are used as the conditions indicating the range from which the character string is extracted, but another item or other items may be included in the conditions.

Accordingly, for example, the character string extracted from the range within the 20 mm downward from the lower right coordinates of the rectangle circumscribing the character string of the item name of “TOTAL” of the item ID of “2” is recognized as a value of the item corresponding to the item name of “TOTAL.”

The general purpose definition information 251 includes information on all items included in the form.

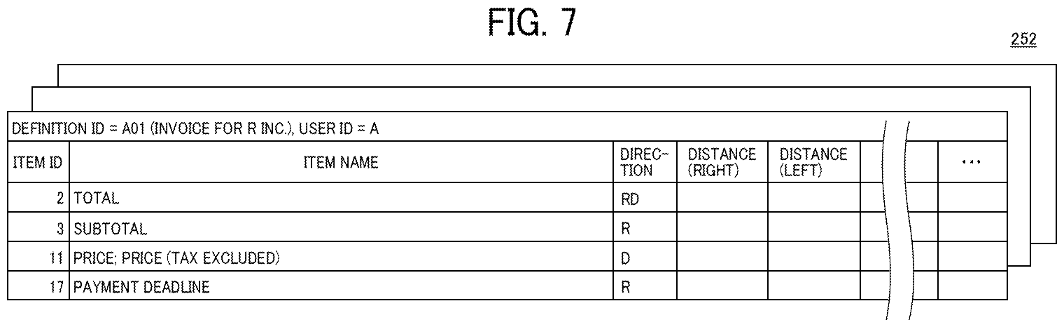

FIG. 7 is a diagram illustrating an example of individual company definition information. The individual company definition information 252 according to the present embodiment is registered for each user, and includes a user ID, a definition ID, an item name, a direction, and a distance, as items of information.

The value of the item of “USER ID” is identification information for identifying a user. In the present embodiment, the definition ID, the item name, the direction, and the distance are the same as those of the general purpose definition information 251, and thus description thereof is omitted below.

In the present embodiment, the definition ID of the form definition information whose definition type is the individual company definition information may include the user ID.

In addition, in the individual company definition information 252, information regarding an item for which an item name and conditions indicating a range in which a value of the item is described are registered by a user is stored. Accordingly, the item ID included in the individual company definition information 252 may be a part of the item ID included in the general purpose definition information 251.

In the example of FIG. 7, the individual company definition information 252 registered by the user ID of “A” is illustrated, and in the individual company definition information 252, the definition ID is “A01” and the document type is “INVOICE FOR R INC.”

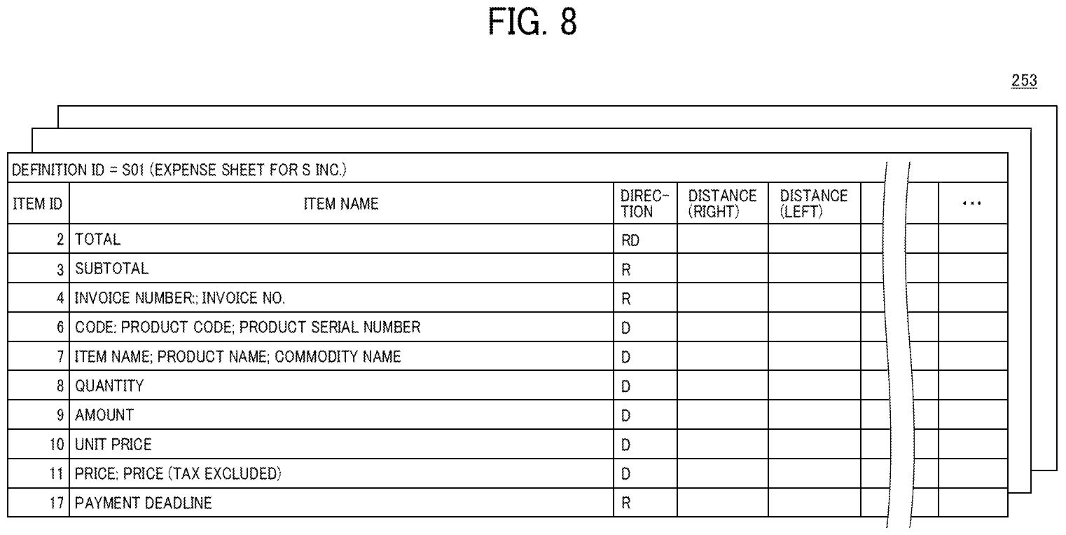

FIG. 8 is a diagram illustrating an example of specific definition information. The specific definition information 253 according to the present embodiment is registered for each specific form, and includes, for example, a definition ID, an item name, a direction, and a distance, as information items. In the present embodiment illustrated in FIG. 8, the definition ID, the item name, the direction, and the distance, are the same as those of the general purpose definition information 251, and thus description thereof is omitted below.

The specific definition information 253 according to the present embodiment may be provided for each specific business operator, or each company.

In this case, the specific definition information 253 may include a company ID as an item of information.

In the following description, an invoice is used as an example of a form, and invoice information is used as an example of form information. In addition, an issuer of an invoice (invoice issuer, billing source) is described as predetermined information (main key) used to manage the invoice information.

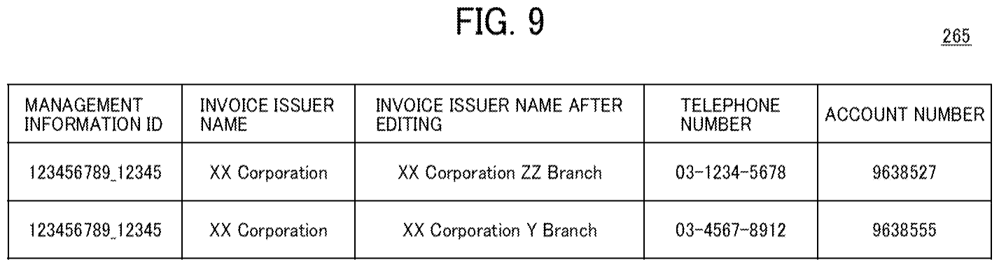

The management information database 265 according to the present embodiment is described below with reference to FIG. 9. FIG. 9 is a diagram illustrating an example of a management information database.

The management information database 265 according to the present embodiment includes, as information items, a management information ID, an invoice issuer name, an invoice issuer name after editing, a telephone number, and an account number.

The value of the item of “MANAGEMENT INFORMATION ID” is information given to the management information (per record) and is identification information for identifying the management information (corresponding to a record). The management information ID may be assigned when the management information is stored in the management information database 265, for example.

The value of the item of “INVOICE ISSUER NAME” indicates a name of a billing source of the invoice, or a name of an invoice issuer. More specifically, the value of the item of “INVOICE ISSUER NAME” includes a corporate name and an individual name, and does not include a branch name or a department name, for example. In other words, the invoice issuer name is the predetermined information.

The value of the item of “INVOICE ISSUER NAME AFTER EDITING” indicates an invoice issuer (billing source) included in the invoice information after editing.

More specifically, the “INVOICE ISSUER NAME AFTER EDITING” indicates the item value after editing of the item of “INVOICE ISSUER” serving as the main key of the invoice information. In other words, the invoice issuer (billing source) of the edited invoice information is the edited predetermined information.

The value of the item “TELEPHONE NUMBER” is a telephone number corresponding to the invoice issuer name after editing, and the value of the item of “account number” is an account number corresponding to the invoice issuer name after editing. In other words, the values of the items of “TELEPHONE NUMBER” and “ACCOUNT NUMBER” can be said to be information for identifying the name of the invoice issuer (billing source) after editing. In other words, the values of the items of “TELEPHONE NUMBER” and “ACCOUNT NUMBER” are information for identifying the issuer of the edited form.

As described above, in the management information stored in the management information database 265 according to the present embodiment, the information indicating the invoice issuer (billing source), the information indicating the edited invoice issuer (billing source), and the information identifying the edited invoice issuer (billing source) are associated with each other.

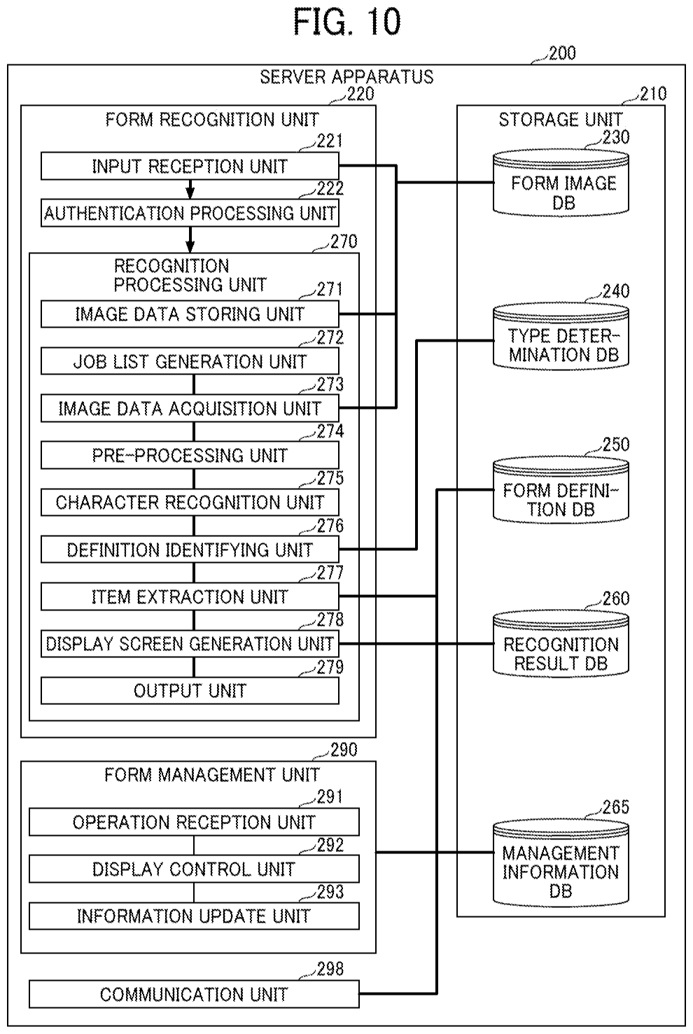

Next, functions, or functional units, of the server apparatus 200 according to the present embodiment are described with reference to FIG. 10. FIG. 10 is a block diagram illustrating a functional configuration of the server apparatus 200 according to the present embodiment.

In the server apparatus 200 according to the present embodiment, for example, the CPU 201 reads and executes an information processing program stored in the RAM 203 or the HD 204, thereby implementing functions of respective units to be described later.

The server apparatus 200 according to the present embodiment includes the form recognition unit 220, the form management unit 290, and a communication unit 298. The form recognition unit 220 includes an input reception unit 221, an authentication processing unit 222, and a recognition processing unit 270. The form management unit 290 includes an operation reception unit 291, a display control unit 292, and an information update unit 293.

In the form recognition unit 220, the input reception unit 221 (first input reception unit) receives various inputs to the server apparatus 200. Specifically, the input reception unit 221 receives an input of authentication information for logging in to the form recognition system 100. The authentication information is, for example, a user ID and a password. The input reception unit 221 receives, for example, input of the form image data transmitted from the image forming apparatus 300. Further, the input reception unit 221 receives various requests and notifications transmitted from the terminal device 400. The input reception unit 221 may receive an input to the server apparatus 200 via the communication unit 298, or may receive an input directly performed to the server apparatus 200.

The authentication processing unit 222 performs authentication based on the authentication information received by the input reception unit 221. For example, the authentication processing unit 222 may transmit the input authentication information to an authentication server provided outside the server apparatus 200 and acquire a result of authentication performed by the authentication server. When the user is authenticated, the authentication processing unit 222 may pass the form image data received by the input reception unit 221 to the recognition processing unit 270.

The recognition processing unit 270 according to the present embodiment includes an image data storing unit 271, a job list generation unit 272, an image data acquisition unit 273, a pre-processing unit 274, a character recognition unit 275, a definition identifying unit 276, an item extraction unit 277, a display screen generation unit 278, and an output unit 279.

When the input reception unit 221 receives the form image data from the image forming apparatus 300 via the communication unit 298, the image data storing unit 271 stores the form image data in the form image database 230.

When the input reception unit 221 receives an input of the form image data from the image forming apparatus 300 via the communication unit 298, the job list generation unit 272 registers a job in a job list and manages the job list. Details of the job list are described later.

The image data acquisition unit 273 acquires the form image data stored in the form image database 230. The pre-processing unit 274 performs pre-processing for form recognition on the form image data acquired by the image data acquisition unit 273.

The character recognition unit 275 extracts a character string and information indicating a position where the character string is arranged from the form image data, and holds the character string and the information as a result of reading. In the description of embodiments, the result of reading may be referred to as reading result data. Details of the reading result data are described later.

The definition identifying unit 276 is an acquisition unit that identifies description definition information to be referred to at the time of performing form recognition based on the character string included in the reading result data and acquires the identified description definition information from the form definition database 250.

The item extraction unit 277 extracts items included in the form image data and values of the items based on the reading result data, generates recognition result data in which the items and the values are associated with each other, and stores the recognition result data in the recognition result database 260.

At this time, the item extraction unit 277 according to the present embodiment refers to the description definition information identified by the definition identifying unit 276, and extracts the description item name described in a description part of the form and a value of a description item in association with each other.

In the following description, information in which the description item name described in the description part of the form is associated with the value of the description item may be referred to as description information. The description information according to the present embodiment is information included in the recognition result data, and is a part of the recognition result data.

In addition, the recognition result data according to the present embodiment includes information (issuer information) indicating an issuer of the form, or a form issuer, described in the form. In other words, the recognition result data includes information indicated by the character string described in the form.

The display screen generation unit 278 generates a recognition result confirmation screen using the recognition result data stored in the recognition result database 260.

The output unit 279 outputs the recognition result confirmation screen generated by the display screen generation unit 278 via the communication unit 298. In other words, the output unit 279 causes the recognition result confirmation screen generated by the display screen generation unit 278 to be displayed on a web browser of the terminal device 400 via the communication unit 298.

The form management unit 290 according to the present embodiment includes an operation reception unit 291, a display control unit 292, and an information update unit 293.

The operation reception unit 291 receives an operation input to a screen displayed on the web browser of the terminal device 400 via the communication unit 298. More specifically, in the present embodiment, the communication unit 298 receives information indicating an operation from the terminal device 400, and the operation reception unit 291 receives an input of the information received by the communication unit 298.

The display control unit 292 (first display control unit) instructs the terminal device 400 to display a screen via the communication unit 298. Specifically, the display control unit 292 causes the terminal device 400 to display an input screen for registering the management information and an input screen for generating the individual company definition information. In addition, the display control unit 292 generates a file in an Extensible Markup Language (XML) format for displaying a screen, and displays the input screen on the web browser of the terminal device 400 via the communication unit 298.

In alternative to the terminal device 400, the server apparatus 200 or another device having a display function may be caused by the display control unit 292 to display a screen. Any device that has a display function can be one to be caused by the display control unit 292 to display a screen.

The information update unit 293 generates the individual company definition information based on the information input from the terminal device 400 and stores the individual company definition information in the form definition database 250. In addition, the information update unit 293 generates the management information based on the information input from the terminal device 400 and stores the management information in the management information database 265.

The communication unit 298 according to the present embodiment is a function implemented by, for example, the network I/F 209, and performs data transmission and reception between the server apparatus 200 and an external device. Specifically, for example, under the control of the display control unit 292, the communication unit 298 transmits a notification for instructing the terminal device 400 to display a screen.

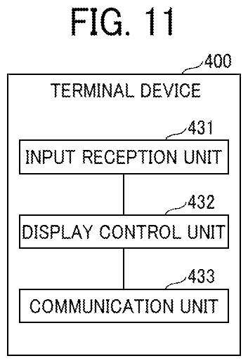

Next, functions, or functional units, of the terminal device 400 according to the present embodiment are described with reference to FIG. 11. FIG. 11 is a block diagram illustrating an example of a functional configuration of the terminal device 400.

Each of the functional units described later is implemented by the CPU 401 of the terminal device 400 reading and executing a program stored in the ROM 402, for example.

The terminal device 400 according to the present embodiment includes an input reception unit 431, a display control unit 432, and a communication unit 433.

The input reception unit 431 (second input reception unit) receives an input to the screen displayed on the web browser of the terminal device 400 by the display control unit 432. Specifically, the input reception unit 431 receives an operation for editing the recognition result on the recognition result confirmation screen displayed on the web browser of the terminal device 400.

The display control unit 432 (second display control unit) controls display on the display 418 of the terminal device 400. Specifically, the display control unit 432 causes the display 418 (display unit) to display a screen according to an instruction from the server apparatus 200.

The communication unit 433 is a functional unit implemented by the long-range communication circuit 412, and the antenna 412a of the long-range communication circuit 412, and performs data transmission and reception between the terminal device 400 and another device.

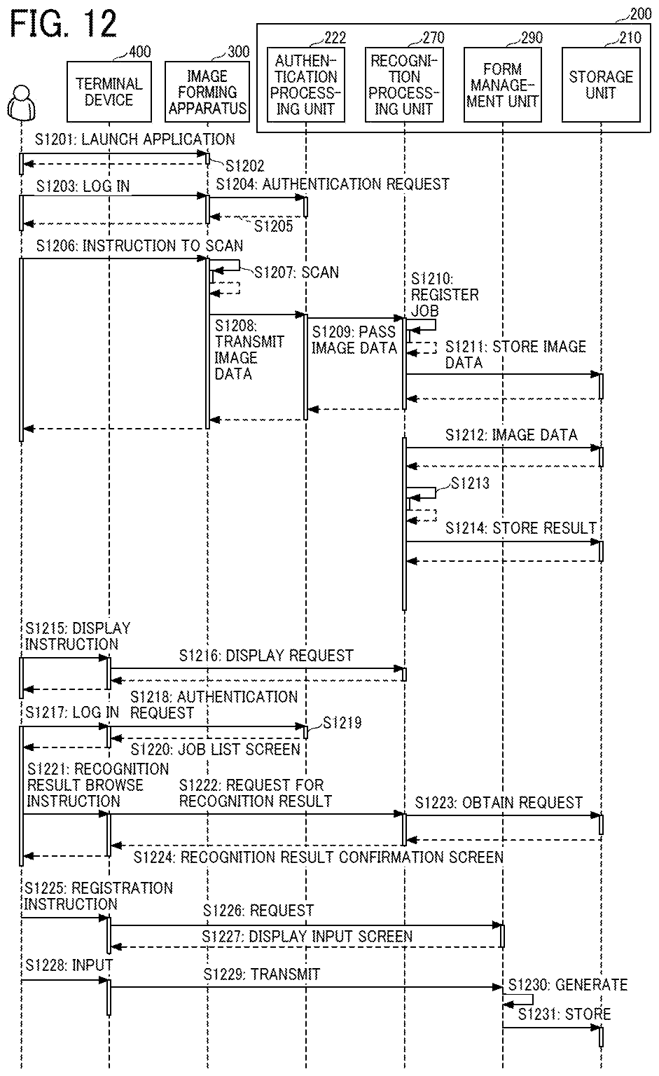

A description is now given of a process performed by the form recognition system 100 according to the present embodiment, with reference to FIG. 12. FIG. 12 is a sequence diagram illustrating an operation of the form recognition system 100 according to the present embodiment.

In the form recognition system 100, when the image forming apparatus 300 receives a request to start an application for performing form recognition (step S1201), the image forming apparatus 300 launches the application (step S1202).

Subsequently, when the image forming apparatus 300 receives an input of authentication information (step S1203), the image forming apparatus 300 transmits the authentication information to the server apparatus 200 to make an authentication request (step S1204).

Upon receiving the authentication request, the server apparatus 200 performs authentication by the authentication processing unit 222, and notifies the image forming apparatus 300 of the result (step S1205). In the following description of the present embodiment, a case where the user is successfully authenticated is described.

Subsequently, the image forming apparatus 300 receives an instruction to scan a form (step S1206), and scans the form to acquire form image data (step S1207). Subsequently, the image forming apparatus 300 transmits the form image data to the server apparatus 200 (step S1208).

In the server apparatus 200, when the input reception unit 221 receives the input of the form image data, the authentication processing unit 222 transfers the form image data to the recognition processing unit 270 (step S1209).

In the example of FIG. 12, the form image data is passed to the recognition processing unit 270 via the authentication processing unit 222, but the present disclosure is not limited thereto. The form image data may be passed to the recognition processing unit 270 without being passed through the authentication processing unit 222.

When receiving the form image data, the recognition processing unit 270 of the server apparatus 200 registers, by the job list generation unit 272, a job in the job list (step S1210). Subsequently, the recognition processing unit 270 stores, by the image data storing unit 271, the form image in the form image database 230 (step S1211).

Subsequently, the recognition processing unit 270 acquires, by the image data acquisition unit 273, the form image data to be recognized from the form image database 230 (step S1212), and executes processing of recognizing the form image (step S1213). Details of the processing in step S1212 are described later.

Subsequently, the recognition processing unit 270 stores the recognition result generated by the item extraction unit 277 in the recognition result database 260 (step S1214).

In the form recognition system 100, when receiving, by the input reception unit 431, an input of a browser display instruction (step S1215), the terminal device 400 transmits a browser display request to the server apparatus 200 via the communication unit 433 (step S1216).

The terminal device 400 receives, by the input reception unit 431, an input of authentication information (step S1217), and transmits, by the communication unit 433, the authentication information to the server apparatus 200 (step S1218).

The server apparatus 200 performs authentication for the user by the authentication processing unit 222 (step S1219), notifies a result of the authentication to the terminal device 400, and displays the job list on the terminal device 400 (step S1220). In the following description of the present embodiment, a case where the user is successfully authenticated is described.

Next, when receiving selection of a job from the job list by the input reception unit 431 (step S1221), the terminal device 400 transmits, based on the selection, a browse request that is corresponding to a browse instruction for a recognition result in relation to the form image to the server apparatus 200 by the communication unit 433 (step S1222).

In response to the browse request, the server apparatus 200 obtains, by the recognition processing unit 270, a recognition result stored in the recognition result database 260 (step S1223), and generates a recognition result confirmation screen to be displayed on the browser of the terminal device 400, so that the user confirms the recognition result on the recognition result confirmation screen displayed on the terminal device 400 (step S1224).

Subsequently, when receiving, by the input reception unit 431, an input of a registration instruction for the individual company definition information and the management information (step S1225), the terminal device 400 transmits a registration request in relation to the individual company definition information and the management information to the server apparatus 200 via the communication unit 433 (step S1226). In other words, the registration request is a display request for displaying an input screen for inputting the individual company definition information and the management information.

In response to receiving the display request by the input reception unit 221, the server apparatus 200 displays, by the display control unit 292 of the form management unit 290, an input screen for inputting the individual company definition information and the management information on the terminal device 400 (step S1227).

Subsequently, upon receiving the input of the individual company definition information and the management information (step S1228), the terminal device 400 transmits the input information to the server apparatus 200 (step S1229).

The form management unit 290 of the server apparatus 200 generates, by the information update unit 293, the individual company definition information and the management information based on the information transmitted from the terminal device 400 (step S1230). Then the form management unit 290 stores, by the information update unit 293, the information in the form definition database 250 and the management information database 265 (step S1231), and the process ends.

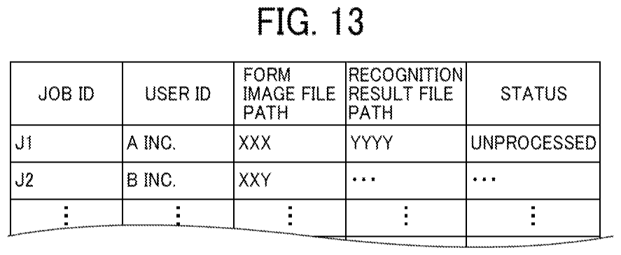

The job list generated by the job list generation unit 272 according to the present embodiment is described with reference to FIG. 13. FIG. 13 is a diagram illustrating an example of a job list.

When the form image data is input from the image forming apparatus 300, the server apparatus 200 according to the present embodiment stores, by the job list generation unit 272, the form image data and a job ID in association with each other as a record of job list.

The job list 101 according to the present embodiment includes, as information items, a job ID, a user ID, a form image file path, a recognition result file path, and a status.

The value of the item of “JOB ID” is identification information for identifying a job. In other words, the value of the item of “JOB ID” is identification information for identifying the form image data received from the image forming apparatus 300.

The value of the item of “USER ID” is identification information for identifying a user who has logged in to the form recognition system 100.

The value of the item of “IMAGE FILE PATH” is information indicating a location where the form image data is stored. The value of the item of “RECOGNITION RESULT FILE PATH” is information indicating a location where the recognition result data corresponding to the result of recognition performed on the form image is stored.

The value of the item of “STATUS” indicates the progress of recognition of the form image. In other words, the value of the item of “STATUS” indicates a status of the job.

In the present embodiment, the value of the item of “STATUS” includes four values, unprocessed, draft saved, confirmed, and external output completed. Explanation of the statuses are given below.
Unprocessed (Status 1): immediately after the recognition result data is obtained by form recognition, and the recognition result is not yet confirmed.
Draft Saved (Status 2): in the middle of processing such as confirming the recognition result data and before the recognition result data is completely confirmed.
Confirmed (Status 3): processing such as confirming of recognition result data is completed, and the recognition result data is stored in the recognition result database 260 as confirmed information.
External output completed (Status 4): output of the recognition result data to the mission-critical system 500 cooperating with the form recognition system 100 is completed.

When receiving the form image data from the image forming apparatus 300, the server apparatus 200 according to the present embodiment assigns a job ID, associates the job ID with a user ID obtained as the authentication information, and adds a record to the job list 101, by the job list generation unit 272. When the form image data is stored in the form image database 230, the job list generation unit 272 adds information indicating a storage destination as a value of the item of “IMAGE FILE PATH.”

Further, when the recognition result data is stored in the recognition result database 260, the job list generation unit 272 adds information indicating the storage destination as the value of the item of “RECOGNITION RESULT FILE PATH,” and sets the value of the item of “STATUS” to the status of Confirmed.

In the present embodiment, for example, the job list generated by the job list generation unit 272 may be displayed. In this case, the user can confirm the progress of the recognition of the form image via the job list screen displayed based on the job list.

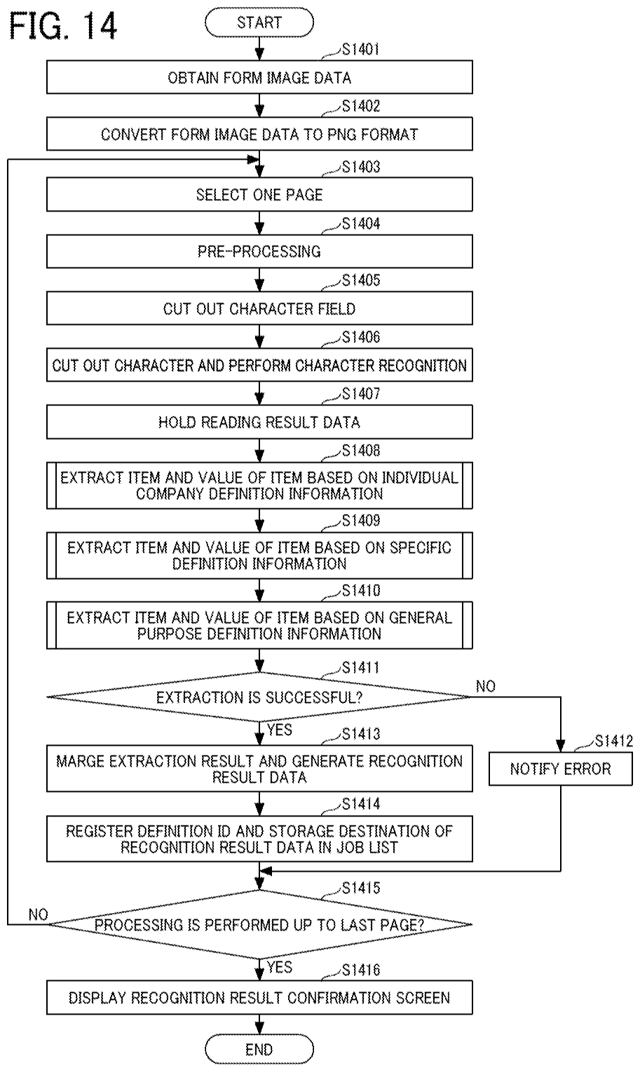

Next, a process performed by the recognition processing unit 270 according to the present embodiment is described with reference to FIG. 14. FIG. 14 is a flowchart illustrating a process performed by the form recognition unit 220 according to the present embodiment. FIG. 14 illustrates details of the process of step S1213 in FIG. 12. FIG. 14 illustrates a process performed when a plurality of form image data is received from the image forming apparatus 300.

When acquiring, by the image data acquisition unit 273, the form image data from the form image database 230 (step S1401), the recognition processing unit 270 according to the present embodiment converts a form image format into a Portable Network Graphics (PNG) format by the pre-processing unit 274 (step S1402).

Subsequently, the pre-processing unit 274 selects one page of the form image data (step S1403) and performs pre-processing (step S1404). Specifically, the pre-processing is, for example, correction processing for aligning the orientation of the form image.

Subsequently, the recognition processing unit 270 cuts out an area in which characters are formed (hereinafter referred to as a character field) from the form image by the character recognition unit 275 (step S1405). Subsequently, the recognition processing unit 270 cuts out a character in the character field cut out and performs character recognition, by the character recognition unit 275 (step S1406). At this time, the character recognition unit 275 also acquires coordinates indicating a position of a character cut out.

Subsequently, the recognition processing unit 270 generates and holds, or obtains, the reading result based on a positional relationship between the characters recognized by the character recognition unit 275 (step S1407). Specifically, the recognition processing unit 270 recognizes characters between which a distance is equal to or less than a predetermined threshold value as a character string, based on the coordinates of each recognized character, associates the character string with information such as the coordinates indicating a position of a portion where the character string is formed, and generates the reading result data. Details of the reading result data are described later.

Subsequently, the recognition processing unit 270 extracts, by the item extraction unit 277, an item and a value of the item using the individual company definition information 252 identified based on the reading result data, the type-determination database 240, and the management information database 265 (step S1408).

Subsequently, the recognition processing unit 270 extracts, by the item extraction unit 277, an item and a value of the item using the specific definition information 253 identified based on the reading result data and the type-determination database 240 (step S1409).

Subsequently, the recognition processing unit 270 extracts, by the item extraction unit 277, an item and a value of the item using the general purpose definition information 251 identified based on the reading result data and the type-determination database 240 (step S1410). Details of processing of each of step S1408 to step S1410 are described later.

Subsequently, the recognition processing unit 270 determines whether the extraction of the item and the value of the item is successful or not (step S1411). For example, the recognition processing unit 270 may determine that the extraction of the item and the value of the item is successful when the item and the value of the item extracted by the item extraction unit 277 are present between step S1408 and step S1410.

In step S1411, when the extraction of the item and the value of the item fails, the recognition processing unit 270 notifies, or reports, an error to the terminal device 400 or the image forming apparatus 300 (step S1412), and the process proceeds to step S1415, which is described below.

When the item and the value of the item are successfully extracted in step S1411, the recognition processing unit 270 generates, by the item extraction unit 277, the recognition result data in which the extracted item and the extracted value of the item are associated with each other and merged (step S1413). The merging process is described in detail later.

Subsequently, the recognition processing unit 270 registers, by the job list generation unit 272, the definition ID of the form definition information used to generate a recognition result and a storage destination of the recognition result data in the job list 101 (step S1414).

Subsequently, the recognition processing unit 270 determines whether or not the processing has been performed up to the last page (step S1415). In step S1415, when the processing has not been performed up to the last page, the process performed by the recognition processing unit 270 returns to step S1403.

When a determination result obtained in step S1415 indicates that the processing has been performed up to the last page, the recognition processing unit 270 displays, by the display screen generation unit 278, the recognition result confirmation screen generated by using the recognition result data on the terminal device 400 (step S1416), and the process ends.

The recognition processing unit 270 may display the recognition result data after receiving a browser request in relation to the recognition result data from the terminal device 400.

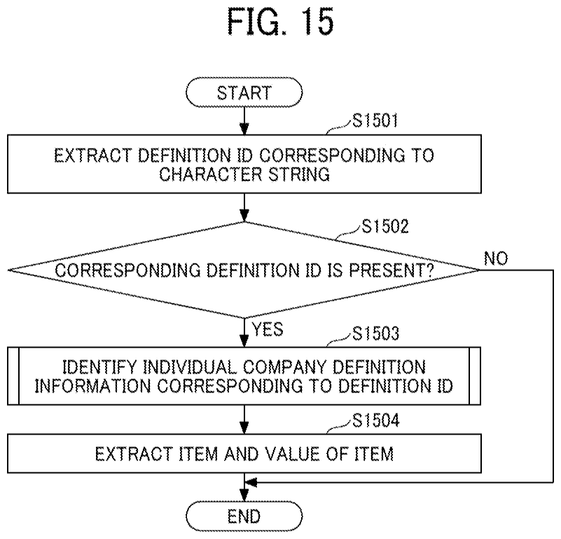

Next, a process performed by the item extraction unit 277 according to the present embodiment is described with reference to FIG. 15. FIG. 15 is a flowchart illustrating a process performed by the form recognition unit 220 according to the present embodiment. FIG. 15 illustrates details of the processing of identifying each piece of definition information performed from step S1408 to step S1410 in FIG. 14.

When the reading result data is held, or obtained, the recognition processing unit 270 according to the present embodiment extracts, by the definition identifying unit 276, a definition ID corresponding to the identification character string included in the reading result data from the type-determination database 240 (step S1501).

Subsequently, the definition identifying unit 276 determines whether a definition ID of which a definition type is individual company definition information is present in the extracted definition IDs or not (step S1502). In other words, whether the individual company definition information 252 is registered for the type of the form indicated by the identification character string included in the reading result data or not is determined.

In step S1502, when the corresponding definition ID is not present, since the individual company definition information 252 defining a layout unique to the user is not registered in the type of the form, the process performed by the item extraction unit 277 ends, and the process proceeds to step S1409 in FIG. 14.

In step S1402, when the corresponding definition ID is present, the definition identifying unit 276 refers to the form definition database 250 and identifies the individual company definition information 252 including the definition ID (step S1503). The case where the corresponding definition ID is present is a case where the form has a layout unique to the user. Details of step S1503 are described later.

Next, the item extraction unit 277 extracts an item and a value of the item from the reading result data based on the identified individual company definition information and associates the item and the value with each other (step S1504).

An extraction process for an item and a value of the item using the specific definition information in step S1409 and an extraction process for an item and a value of the item using the general purpose definition information 251 in step S1410 are substantially the same as the extraction process for the item and the value of the item using the individual company definition information in step S1408, except for the individual company definition information is replaced with the specific definition information and the general purpose definition information, respectively, and thus the description thereof is omitted.

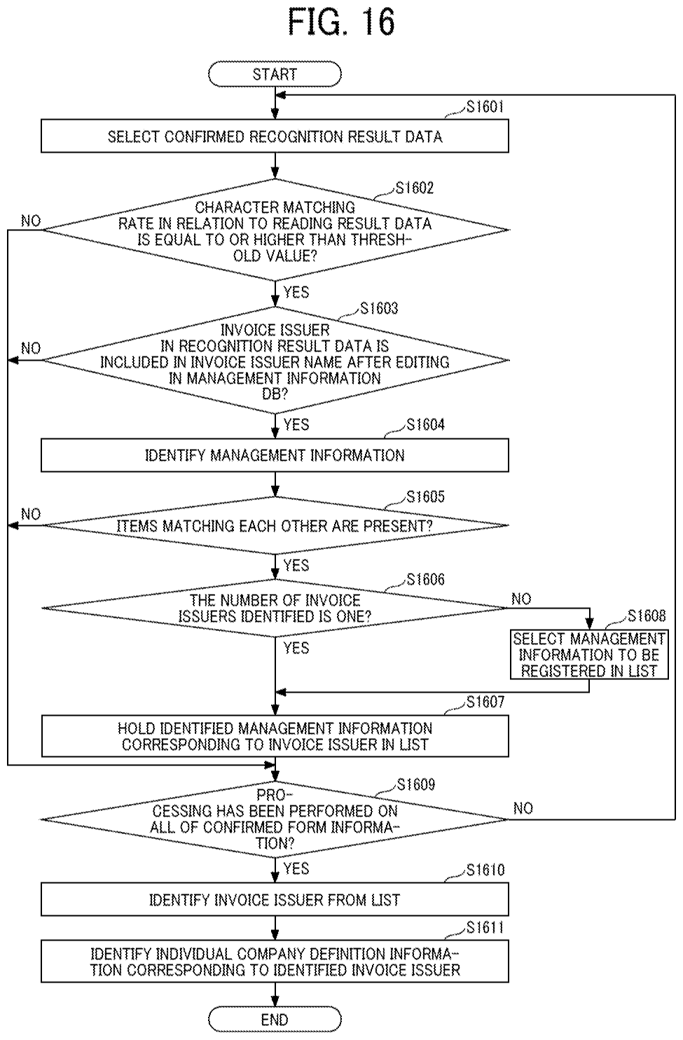

Next, a process for identifying individual company definition information is described with reference to FIG. 16. FIG. 16 is a flowchart illustrating a process performed by the form recognition unit 220 according to the present embodiment. FIG. 16 illustrates details of the processing of the definition identifying unit 276 in step S1503 of FIG. 15. More specifically, FIG. 16 illustrates a process of identifying individual company definition information.

The definition identifying unit 276 according to the present embodiment selects recognition result data that has been determined as a status of Confirmed from among all of the recognition result data stored in the recognition result database 260 (step S1601).

Subsequently, the definition identifying unit 276 compares the selected recognition result data with the reading result data held in step S1407 of FIG. 14, and determines whether a matching rate of characters, or a character matching rate, is equal to or higher than a predetermined threshold value or not (step S1602).

When a determination result obtained in step S1602 indicates that the character matching rate is less than the predetermined value, the process performed by the definition identifying unit 276 proceeds to step S1609, which is described later.

When a determination result obtained in step S1602 indicates that the character matching rate is equal to or higher than the predetermined value, the definition identifying unit 276 determines whether the value of the item of “INVOICE ISSUER” is included in the item of “INVOICE ISSUER NAME AFTER EDITING” in the management information database 265 (step S1603). In step S1603, when the value of the item of “INVOICE ISSUER” is not included in the item of “INVOICE ISSUER NAME” of the management information database 265, the process performed by the definition identifying unit 276 proceeds to step S1609, which is described later.

In step S1603, when the value of the item of “INVOICE ISSUER” is included in the item of “INVOICE ISSUER NAME” of the management information database 265, the definition identifying unit 276 identifies the management information in which the value of the item of “INVOICE ISSUER NAME” matches the value of the item “INVOICE ISSUER” (step S1604).

Next, the definition identifying unit 276 determines whether there is an item of which a value matches a value of an item included in the identified management information (step S1605). In step S1605, the value of the item may not completely match the value of the item included in the identified management information. In a case that the value of the item matches a part of the value of the item included in the identified management information, this case is determined that the values match.

In step S1605, when there is no corresponding item, the process performed by the definition identifying unit 276 proceeds to step 51609, which is described later.

In Step S1605, when there is a corresponding item, whether the number of invoice issuers (billing sources) identified by the corresponding item is one or not is determined (Step S1606).

When the number of invoice issuers (billing sources) identified is one in step 51606, the definition identifying unit 276 holds the identified management information in the list as management information to be referred to when identifying the invoice issuer (billing source) (step S1607), and the process proceeds to step S1609. The list may hold the management information ID, which is included in the management information, alone.

In step S1606, when the number of invoice issuers (billing sources) identified is not one, the definition identifying unit 276 selects management information to be registered with the list (step S1608), and the process proceeds to step S1607.

Specifically, the definition identifying unit 276 selects the management information, from among all of the identified management information, one that has the largest number of character strings matched ones included in the reading result data.

When the management information is stored in the list, the definition identifying unit 276 determines whether the processing up to step S1608 has been performed on all of the recognition result data having the status of Confirmed in the recognition result database 260 or not (step S1609).

When a determination obtained in step S1609 indicates that the processing has not been performed on all of the recognition result data having the status of Confirmed, the process performed by the definition identifying unit 276 returns to step S1601.

When a determination obtained in step S1609 indicates that the processing has been performed on all of the recognition result data having the status of Confirmed, the definition identifying unit 276 refers to the management information stored in the list and identifies the invoice issuer (billing source) (step S1610).

Specifically, the definition identifying unit 276 identifies the management information, from among all of the management information stored in the list, one that has the largest number of character strings matched ones included in the reading result data, and identifies the invoice issuer name in the identified management information as the invoice issuer (billing source).

Subsequently, the definition identifying unit 276 identifies the individual company definition information corresponding to the identified invoice issuer (billing source) as individual company definition information to be used for form recognition (step S1611), and the process ends.

In this embodiment, as described above, the invoice issuer (billing source) is identified by using the management information stored in the management information database 265. Accordingly, according to the present embodiment, the invoice issuer (billing source) can be identified with high accuracy.

Furthermore, in the present embodiment, since the invoice issuer (billing source) can be identified with high accuracy, appropriate individual company definition information can be identified, resulting in improving the accuracy of form recognition.

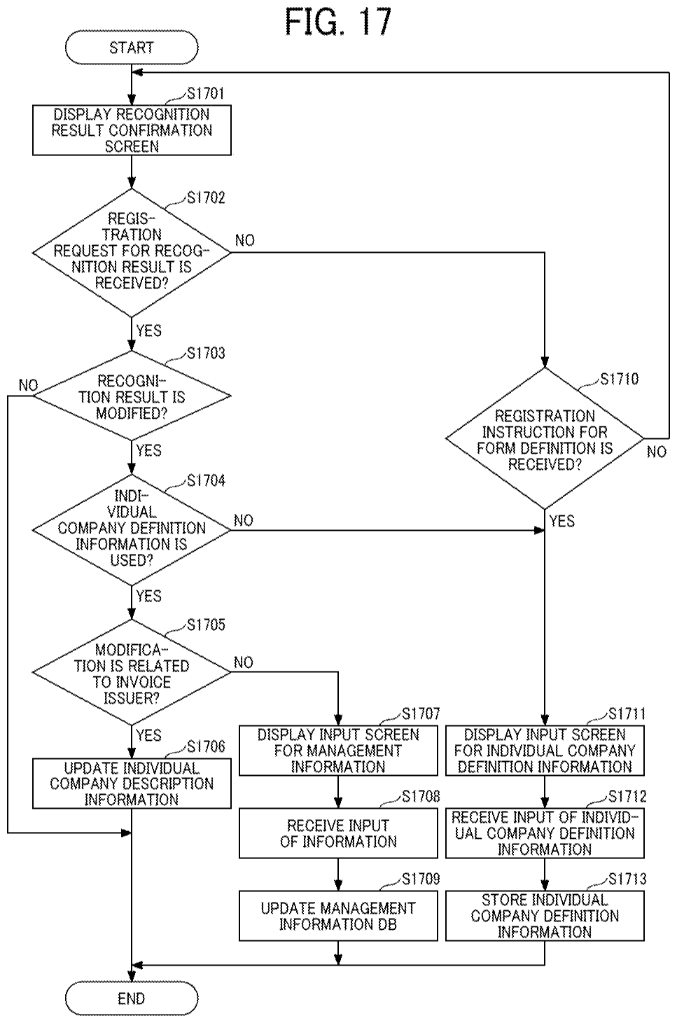

Next, registration of the management information by the form management unit 290 is described with reference to FIG. 17.

FIG. 17 is a flowchart illustrating a process performed by the form management unit 290 according to the present embodiment. FIG. 17 illustrates details of the processing from step S1221 to step S1231 in FIG. 12.

When the form management unit 290 according to the present embodiment receives, by the operation reception unit 291, a browse instruction for the recognition result data from the terminal device 400, and displays, by the display control unit 292, a recognition result confirmation screen for the recognition result data on the terminal device 400 (step S1701).

Next, the form management unit 290 determines whether a registration request for the recognition result data has been received by the operation reception unit 291 from the terminal device 400 or not (step S1702). Specifically, the server apparatus 200 determines whether storing, in the recognition result database 260, the recognition result data displayed on the recognition result confirmation screen has been instructed or not.

In step S1702, when the registration request is not received, the process performed by the form management unit 290 proceeds to step S1707, which is described later.

When the registration request is received in step S1702, the form management unit 290 determines whether the recognition result data has been modified or not (step S1703).

In step S1703, when the modification is not performed, the process performed by the form management unit 290 ends.

In step S1703, when the modification is performed, the form management unit 290 determines whether the individual company definition information 252 is referred to or not (step S1704). Specifically, the form management unit 290 determines whether the individual company definition information 252 associated with the invoice issuer (billing source) included in the reading result data is present or not.

In step S1704, when the individual company definition information is not referred to, the process performed by the form management unit 290 proceeds to step S1708, which is described later.

In step S1704, when the individual company definition information is referred to, the form management unit 290 determines whether the modified portion is the invoice issuer (billing source) or not, namely the modification is related to the invoice issuer (billing source) or not (step S1705).

In step S1705, when the modification (modified part), or the edition (edited part), is not related the invoice issuer (billing source), the form management unit 290 updates, by the information update unit 293, the individual company definition information in accordance with the modification, or the edition (step S1706), and the process ends. The case where the modification is not related to the invoice issuer (billing source) is, for example, a case where the description part in the recognition result data is modified.

In the present embodiment, the recognition result data may be registered after the process performed by the form management unit 290 is completed. Specifically, the form management unit 290 may store the recognition result data in the recognition result database 260 after the process of FIG. 17 is completed.

In step S1705, when the modification (modified part), or the edition (edited part), is related to the invoice issuer (billing source), the form management unit 290 displays, by the display control unit 292, an input screen for management information on the terminal device 400 (step S1707).

Subsequently, the form management unit 290 receives, by the operation reception unit 291, an input of information on the input screen displayed on the terminal device 400 (step S1708).

Subsequently, the form management unit 290 updates, by the information update unit 293, the management information database 265 (step S1709), and the process ends.

Specifically, the information update unit 293 generates the management information by associating the information input on the input screen with the invoice issuer (billing source) modified, or edited, on the recognition result confirmation screen for the recognition result data, and stores the generated management information in the management information database 265.

The invoice issuer (billing source) modified, or edited, on the recognition result confirmation screen is, in other words, an invoice issuer after editing and edited predetermined information.

In step S1702, when the registration request for the recognition result data is not received, the form management unit 290 determines whether a registration instruction for the form definition is received by the operation reception unit 291 or not (step S1710).

In step S1710, when the registration instruction for the form definition is not received, the form management unit 290 returns to step S1701.

When the registration instruction for the form definition is received in step S1701, the form management unit 290 displays, by the display control unit 292, an input screen for the individual company definition information 252 on the terminal device 400 (step S1711).

Subsequently, the form management unit 290 receives an input of individual company definition information through the input screen by the operation reception unit 291 (step S1712).

Subsequently, the form management unit 290 stores, by the information update unit 293, the input individual company definition information 252 in the form definition database 250 (step S1713), and the process ends.

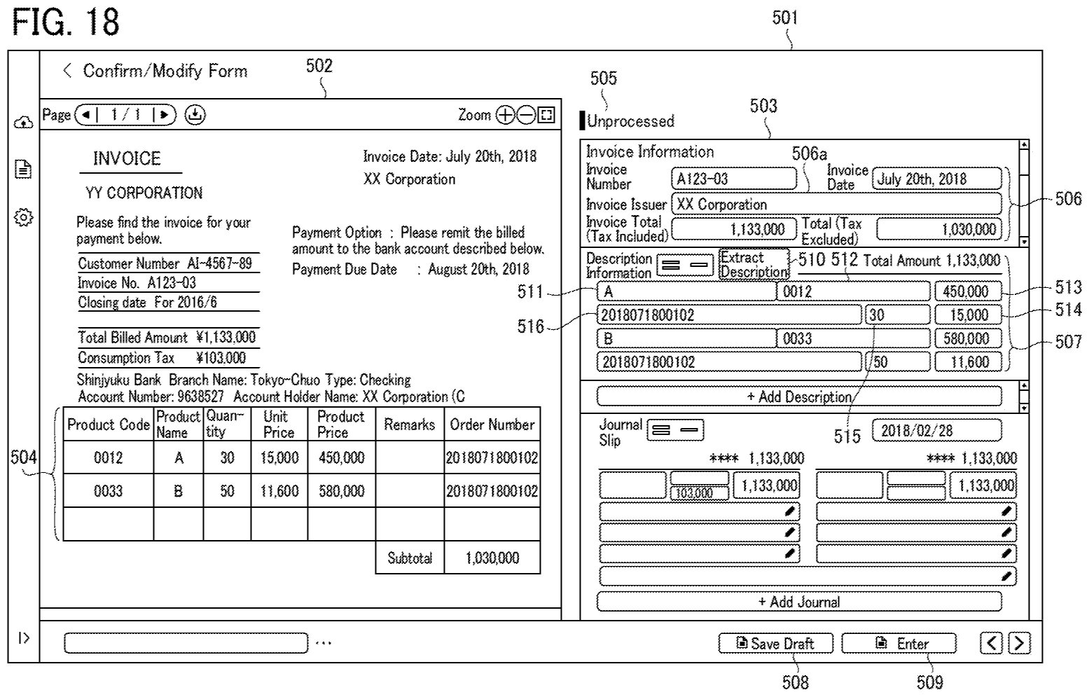

Display examples of the terminal device 400 are described below with reference to FIGS. 18 to 20. FIG. 18 is a diagram illustrating a display example of the terminal device 400.

A screen 501 illustrated in FIG. 18 is an example of a recognition result confirmation screen displayed on the terminal device 400 in step S1224 of FIG. 11.

The screen 501 includes a display field 502, a display field 503, and display components 508 and 509. The form image represented by the form image data is displayed in the display field 502. In the example of FIG. 18, the form is an invoice, and an area 504 indicating the description part in the form image is included.

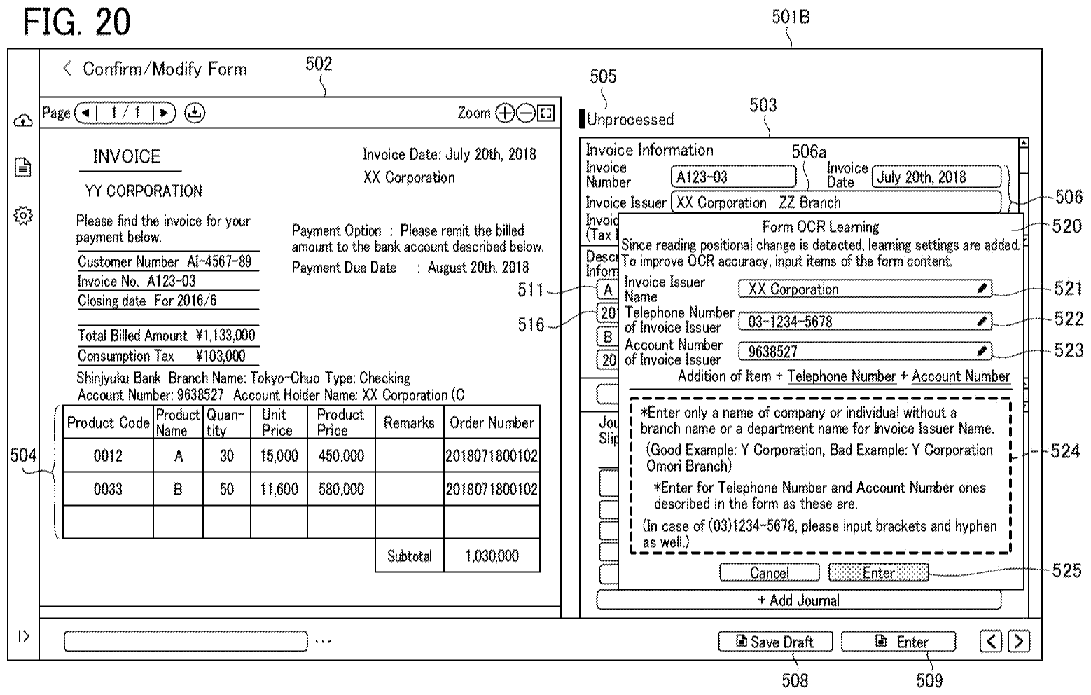

As illustrated in FIG. 20, the description part in the form image is represented in a table format. In other words, the description part in the form image is an example of an image in a table format.

The display field 503 displays the recognition result data as a result of form recognition performed by the form recognition unit 220 on the form image data representing the form image displayed in the display field 502.

The display field 503 includes display fields 505, 506, and 507. The display field 505 displays a value of the item of “STATUS” in the job list 101. The display field 506 displays the invoice issuer (billing source) information including the invoice issuer (billing source). The invoice issuer (billing source) information is a part of the recognition result data.

The display field 506 includes a display field 506a. An invoice issuer name, “XX Corporation,” is displayed in the display field 506a. The invoice issuer name displayed in the display field 506a illustrated in FIG. 18 is an invoice issuer name extracted from the form image data displayed in the display field 502. In other words, in the display field 506a illustrated in FIG. 18, the invoice issuer name before editing is displayed.

The description information is displayed in the display field 507. Specifically, a list of values of description items included in the description information is displayed in the display field 507. The display field 507 includes display fields 511, 512, 513, 514, 515, and 516. The display field 507 includes a display component 510.

The display component 510 is a display component for instructing display of an extraction guide image. In other words, the display component 510 is a display component for notifying the server apparatus 200 of a setting instruction of an area of an item name and an item value to be extracted from an image in a table format.

In the display field 511, a value of a description item of a description item name of “Product Name” displayed in the area 504 indicating the description part in the form image is displayed. In the display field 512, a value of a description item of a description item name of “Product Code” displayed in the area 504 is displayed. In the display field 513, a value of a description item of a description item name of “Product Price” displayed in the area 504 is displayed.

In the display field 514, a value of a description item of a description item name of “Unit Price” displayed in the area 504 is displayed. In the display field 515, a value of a description item of a description item name of “Quantity” displayed in the area 504 is displayed. In the display field 516, a value of a description item of a description item name of “Order Number” displayed in the area 504 is displayed.

In the present embodiment, as described above, the item values are extracted from the items corresponding to the respective description item names in the description part of the form image and are displayed in the display fields 511, 512, 513, 514, 515, and 516. In other words, the items corresponding to the description item names are items to be extracted (extraction target items). The items to be extracted may be fixedly determined or may be changed by user.

The example of FIG. 18 illustrates a case where the extraction of the recognition result data from the form image data is successful. Accordingly, the values of all the description item names of the description part displayed in the area 504 are displayed in the display field 507.

The display component 508 is a display component for changing the status value of the job list 101 from a status of Unprocessed to a status of Draft Saved. When the display component 508 is operated, the display field 505 changes from “Unprocessed” to “Draft Saved.”

The display component 509 is a display component for setting a value of the status of the job list 101 to a status of Confirmed. In the present embodiment, when the display component 509 is operated, the status value of the job list 101 is set to the status of Confirmed, and the individual company definition information 252 is not generated.

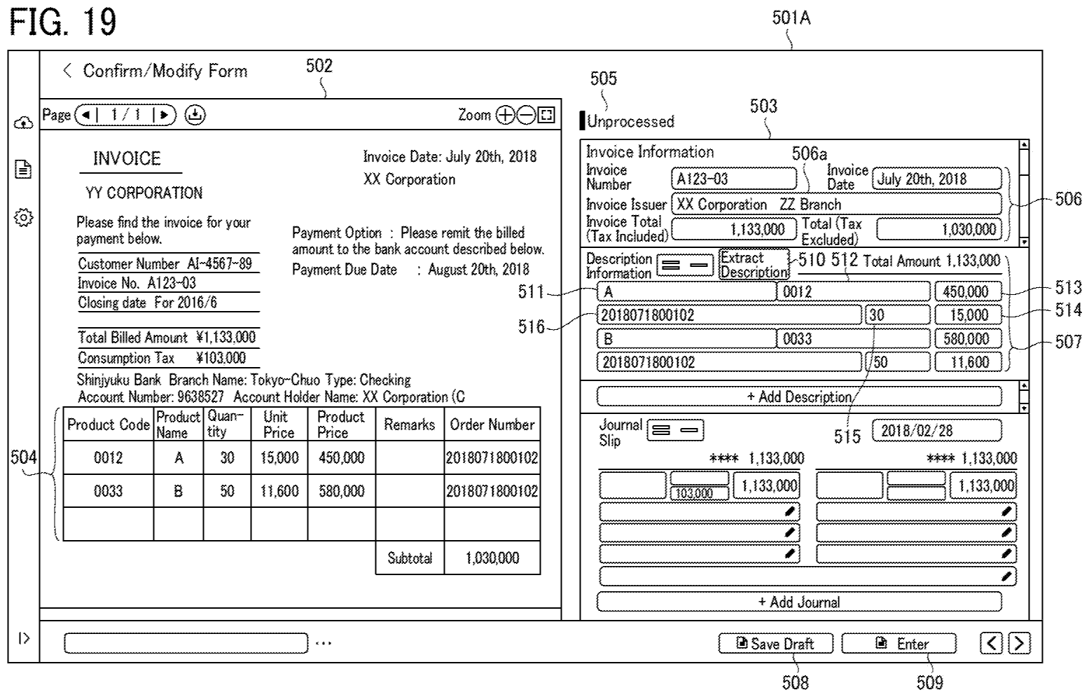

Next, with reference to FIG. 19, a description is given of a case where the invoice issuer (billing source) is edited. FIG. 19 is a diagram illustrating another display example of the terminal device 400.

In a screen 501A illustrated in FIG. 19, “ZZ branch” is input in the display field 506a in addition to the name of the invoice issuer (billing source) before editing “YY Corporation.” In other words, in the screen 501A illustrated in FIG. 19, the invoice issuer name is edited, and the invoice issuer name after editing is displayed in the display field 506a.

In the present embodiment, when the display component 509 is operated on the screen 501A illustrated in FIG. 19, an input screen for inputting information related to the invoice issuer name before editing, which is displayed in the display field 506a illustrated in FIG. 18, is displayed.

The input screen is described with reference to FIG. 20. FIG. 20 is a diagram illustrating still another display example of the terminal device 400.

An input screen 520 is displayed on a screen 501B illustrated in FIG. 20. The input screen 520 includes input fields 521, 522, and 523, a display field 524, and a display component 525.

The input field 521 is an input field for inputting an invoice issuer name, the input field 522 is an input field for inputting a telephone number of the invoice issuer (billing source), and the input field 523 is an input field for inputting an account number of the invoice issuer (billing source).

In other words, the invoice issuer name before editing is input to the input field 521, and information for identifying the invoice issuer (billing source) after editing is input to the input fields 522 and 523.

The display field 524 displays a caution when information is input to the input fields 521, 522, and 523. Specifically, the display field 524 displays a message prompting the user to input a corporate name or an individual name without inputting a branch name or a department name when inputting an invoice issuer (billing source) to the input field 521. In addition, in the display field 524, messages prompting the user to input in the input fields 522 and 523, respectively, the telephone number and the account number included in the form image displayed in the display field 502.

The display component 525 is operated after input to the input fields 521 to 523 is completed. In the present embodiment, when input to the input fields 521 to 523 is completed and the display component 525 is operated, the terminal device 400 transmits the information input on the input screen 520 to the server apparatus 200.

Upon receiving the information input on the input screen, the server apparatus 200 associates the information with the edited invoice issuer (billing source) displayed in the display field 506a to generate the management information, and stores the management information in the management information database 265.

In the example of FIG. 20, the invoice issuer (billing source) after editing “XX Corporation ZZ branch” displayed in the display field 506a, the invoice issuer (billing source) before editing “XX Corporation” input in the input field 521, the telephone number input in the input field 522, and the account number input in the input field 523 are associated with one another to generate the management information.

As described above, in the present embodiment, when the invoice issuer (billing source) is edited in the recognition result data, the input screen for inputting information for associating the invoice issuer (billing source) after editing with the invoice issuer (billing source) before editing is displayed on the terminal device 400. In the present embodiment, the management information in which the input information and the invoice issuer (billing source) after editing are associated with each other is generated and stored in the management information database 265, whereby the invoice issuer (billing source) after editing and the invoice issuer (billing source) before editing can be managed as separate items.

Accordingly, according to the present embodiment, even when the issuer of the form extracted in the form recognition is edited by the user, the form information can be efficiently managed in the same manner as before the issuer is edited by referring to the management information database 265.

In the following, it is assumed that the mission-critical system 500 is an accounting system, and a user of the form recognition system 100 uses the recognition result data in the accounting system, and a description is given of a case in which editing is performed to add, to an invoice issuer (company name), character strings such as a branch name of the invoice issuer (billing source), a branch name of a billing destination, and a purpose of the recognition result data.

In this case, the character strings added by the editing are not described as a set of character strings with the invoice issuer (billing source) on the invoice (form) and are not associated with the invoice issuer (billing source). For this reason, when the invoice issuer after editing is registered as the invoice issuer in the individual company definition information, there is a possibility that the recognition accuracy of the invoice issuer in the form recognition decreases.

In the present embodiment, when a character string that is not associated with the invoice issuer (billing source) on the form is edited as an invoice issuer (billing source) as described above, the invoice issuer on the form and the invoice issuer after editing are managed as separate items in association with each other.

Accordingly, in the present embodiment, even when such editing is performed, the recognition result data can be managed in the form recognition system 100 without being complicated.

In other words, in the present embodiment, even in a case where the user of the form recognition system 100 edits the form information in a different way of describing the invoice issuer (billing source), the form information can be managed without being complicated.

In the present embodiment, when form recognition is performed, the individual company definition information to be used is identified by referring to the management information database 265. Accordingly, according to the present embodiment, the accuracy of form recognition can be improved.

According to an embodiment, a non-transitory recording medium storing a plurality of instructions which, when executed by one or more processors, causes the processors to perform a method is provided. The method includes displaying, on a display of a terminal device, an input screen, in a case that predetermined information included in form information is edited and edited predetermined information is obtained. The input screen is for inputting information related to the edited predetermined information. The form information is information on a form. The method includes storing, in a memory, management information in which the information input via the input screen and the edited predetermined information are associated with each other.

Editing of predetermined information included in form information managed by a system according to a related art can be performed according to convenience of a user, and due to this, managing of the form information can be complicated.

According to an embodiment of the disclosure, form information can be managed more efficiently.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor

The apparatuses or devices described in the embodiments described above are merely one example of plural computing environments that implement one or more embodiments of the disclosure.

In some embodiments, the server apparatus 200 includes multiple computing devices such as server clusters. The plurality of computing devices is configured to communicate with one another via any type of communication link, including a network or shared memory to implement the processing described in the present embodiment. In substantially the same manner, for example, the server apparatus 200 includes such multiple computing devices configured to communicate with one another.

Further, the server apparatus 200 can be configured to share the disclosed processes in various combinations. For example, a process executed by the server apparatus 200 may be executed by another server apparatus. Similarly, a function of the server apparatus 200 may be performed by another server apparatus. Each functional configuration of the server apparatus and the other server apparatus may be combined into one server or may be divided into a plurality of devices.

The database according to the above-described embodiments may be generated by machine learning. By classifying keywords and accounting items that can be included in transaction content, the use of the correspondence tables may be optional.

In the present disclosure, the machine learning is defined as a technology that makes a computer to acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

Although the description above is given based on each of the above-described embodiments, the present disclosure is not limited to the requirements described in the above embodiments. In regard to these points, the configuration can be modified without departing from the spirit of the present disclosure, and can be appropriately set according to an applied configuration.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus, comprising
circuitry configured to:
display, on a display of a terminal device, an input screen, in a case that predetermined information included in form information is edited and edited predetermined information is obtained, the input screen being for inputting information related to the edited predetermined information, the form information being information representing a content of a form; and
store, in a memory, management information in which the information input via the input screen and the edited predetermined information are associated with each other.

2. The information processing apparatus of claim 1, wherein
the information related to the edited predetermined information includes the predetermined information and identification information that identifies the edited predetermined information.

3. The information processing apparatus of claim 1, wherein
the input screen is displayed with a form image including the form information, the form image being represented by form image data.

4. The information processing apparatus of claim 3, wherein
the predetermined information includes information indicating an issuer of the form indicated by the form image.

5. The information processing apparatus of claim 1, wherein
the memory stores, for each form unique to a user, form definition information defining one or more items of the form and a positional relationship between one or more values of the one or more items of the form, and
the circuitry is further configured to identify the form definition information to be referred to in extracting the form information from a form image based on the management information stored in the memory.

6. An information processing method, comprising:
displaying, on a display of a terminal device, an input screen, in a case that predetermined information included in form information is edited and edited predetermined information is obtained, the input screen being for inputting information related to the edited predetermined information, the form information being information representing a content of a form; and
storing, in a memory, management information in which the information input via the input screen and the edited predetermined information are associated with each other.

7. The information processing method of claim 6, wherein
the information related to the edited predetermined information includes the predetermined information and identification information that identifies the edited predetermined information.

8. The information processing method of claim 6, wherein
the input screen is displayed with a form image including the form information, the form image being represented by form image data.

9. The information processing method of claim 8, wherein
the predetermined information includes information indicating an issuer of the form indicated by the form image.

10. The information processing method of claim 6, further comprising:
storing, in the memory, for each form unique to a user, form definition information defining one or more items of the form and a positional relationship between one or more values of the one or more items of the form; and
identifying the form definition information to be referred to in extracting the form information from a form image based on the management information stored in the memory.

11. An information processing system, comprising:
an information processing apparatus including information processing circuitry; and
a terminal device including terminal device circuitry and connected to the information processing apparatus via a network,
the information processing circuitry being configured to:
receive a display request transmitted from the terminal device in a case that predetermined information included in form information is edited, and edited predetermined is obtained on the terminal device, the form information being information representing a content of a form;
display, in response to the display request, on a display of the terminal device, an input screen for inputting information related to the edited predetermined information; and
store, in a memory, management information in which the information input via the input screen and the edited predetermined information are associated with each other,
the terminal device circuitry being configured to:
receive an operation of editing the form information; and
control the display to display the input screen.
